(19) United States
(12) Patent Application Publication
(10) Pub. No.: US 2011/0202591 A1
(43) Pub. Date: Aug. 18, 2011

(54) SYSTEM, METHOD, AND APPARATUS FOR IMPROVED TRANSPORTATION MANAGEMENT

(76) Inventors: Victor Reis, Morrisville, NC (US); Stephen A. Stone, Tenafly, NJ (US); Patrick V. Bellone, Fanwood, NJ (US)

(21) Appl. No.: 12/531,147

(22) PCT Filed: Mar. 14, 2008
(86) PCT No.: PCT/US08/57112

§ 371 Date: Apr. 28, 2011

Related U.S. Application Data
(60) Provisional application No. 60/894,754, filed on Mar. 14, 2007.

(51) Int. Cl. G06F 15/16

(52) U.S. Cl. 709/203; 709/246

(57) ABSTRACT

A system, method, and apparatus infrastructure provide real time wireless tracking of multiple initial data parameters transmitted from individual mobile receiving or system units installed in customer vehicles. A management network receives and decodes initial data parameters from respective receiving mobile units, matches and encodes the same according to stored predetermined customer specified format preferences, and transmits customer specified data streams to customers. An additional step correlates the received specified-data streams with additional public-supplied data or third-party contractually supplied data to provide an enhanced customer report enabling a number of reports; including a credibility determination between the public-supplied data and the received specified-data, a customer vehicle travel efficiency report, a safe operation vehicle report, and a vehicle operator effectiveness report. Each vehicle system unit is functionally enabled to secure transmission of a communication protocol over GSM, GPRS, CDMA, or other networks enabling seamless and secure functionality between wireless or wired data-links.

### CROSS REFERENCE TO RELATED APPLICATIONS

This application references and claims priority to U.S. Prov. App. No. 60/894,754 filed Mar. 14, 2007, the entire contents of which are herein incorporated by reference.

### BACKGROUND OF THE INVENTION

1. Field of the Invention

The present invention relates to an integrated system, method, and apparatus for effecting transportation fleet management. More specifically, the present invention relates to a system enabling improved real time capture of vehicle data and distribution of blended summary data via a networked computer system.

2. Description of the Related Art

The related art involves a variety of fleet operator systems employing antiquated asset tracking systems. These systems range in complexity from simple phone in or text message systems, to the presently preferred automatic vehicle location (AVL) systems known to the art.

Included in this grouping are Applicant's related vehicle and phone network vehicle location systems identified in U.S. Pat. No. 5,999,680 granted Dec. 7, 1999, U.S. Pat. No. 6,085,097 granted Jul. 4, 2000, U.S. Pat. No. 6,477,363 granted Nov. 5, 2002, European Pat. No. 09 44 229 granted Jan. 22, 2003, and Canadian Pat. No. 22 61 503 granted Apr. 22, 2003. The entire contents of each of these references is incorporated herein by reference to assist an understanding of the background.

Collectively, these references broadly discuss a telephone network system for communicating location or status information concerning a mobile unit by cellular telephone coupled with the mobile unit in which sensed location or status information at any selected instant of time is converted to one of a multiple of coded, assigned telephone call-numbers uniquely identifying such information at that time, where the assigned call-number is transmitted over the network, and where the assigned call-number is received at a remote location, with the location or status information being extracted before any telephone call-connection from the mobile unit to the remote location is completed.

These coded, assigned telephone call-numbers are reserved by the system operator from the telephone company serving the area of the remote location, and extracting the location or status information before any telephone call-connection is completed saves the costs to an end user of the mobile unit associated with a conventional telephone call-connection.

Unfortunately, the majority of fleet operators continue to use related and hence inefficient antiquated asset tracking systems. Security and the threat of terrorism related to hazardous materials, fuel consumption, vehicle theft, vehicle misuse, driver negligence, insurance fraud, accidents, and high insurance rates for commercial and private fleets are all factors that directly impact fleet operating costs for business and government agencies.

While lacking in the current inventive state of the art, it is recognized by the inventors that an effective AVL solution, should result in greater profitability, improved driver and pedestrian safety, enhanced public safety, and should help prevent terrorism. As a consequence, the present inventors have identified a previously unrecognized and unsatisfied commercial need.

The conventional AVL based systems have grow to over 1.3 million units with a projected annual growth rate of between 5-8%. Of the 20-25 million fleet vehicles operating in the U.S., approximately 1.36 million fleet vehicles are currently equipped with installed vehicle location (AVL) systems, in the following categories: (i) 920,000 local fleet vehicles, including service, delivery, public safety, public transit and government fleets; and (ii) 440,000 systems on long haul trucks.

Since 2003, the total installed base of fleet AVL units has increased from an estimated 1.0 million units to 1.36 million units, which equates to approximately 13% annual growth. Most of this growth has occurred in the local fleet vehicle tracking market, where the installed base has increased from approximately 500,000 units to 920,000 units, i.e. just over 27% unit growth per year. The long haul trucking market, has estimated subscriber growth of about 7% annually.

While a few vertical markets, including long haul trucking and public transit, have a high percentage of AVL penetration, overall less than 7%, in 2005, of U.S. fleet vehicles were equipped with AVL systems. Projections for 2006 approximate 8.4% of the AVL market will be using AVL systems. Unfortunately, despite this growth rate, the true expansion of the AVL market has been long restrained by the failure of the present AVL systems to consider and adapt to the potential market and the requirements for enhanced data delivery and report analysis.

The inventors have recognized that contributing to the increased economic stress and safety issues which should drive a demand for automatic vehicle location systems include: (i) high fleet operating costs; (ii) growing mobile work force; and (iii) a government focus on security and a means to prevent future terrorist attacks, and that heretofore these have not been recognized.

Controlling costs and providing safety assurances are the two overlapping fundamental issues plaguing the majority of public and private fleets in the AVL market, and no solution has been provided to date. The use of AVL systems improves fleet related safety and decreases fleet operating expenses, which greatly help to improve the bottom line. The applicants now recognize that industry issues include rising fuel costs, insurance costs, hours-of-service, tolls/highway funding, tort reform/ legal issues. Insurance costs, for example, rose dramatically over a three-year period between 2001 and 2003. Fleets seek insurance recognition for safety practices and technology deployments based upon cognizable reporting structures that are simply lacking in today's technology. Fleet managers need the ability to identify specific cost reduction strategies and have been without a solution prior to the present invention.

The applicants have recognized that a number of dynamics will induce the commercial market to consider their suggested innovations, including; (i) Department of Homeland Security (DHS) & Department of Transportation (DOT) initiatives, such as SAFETEA-LU (Safe, Accountable, Flexible, Efficient Transportation Equity Act: A Legacy for Users) and hazardous material (hazmat) transportation, (ii) strong commercial and municipal wireless spending, (iii) enhanced wireless technologies, (iv) affordable AVL systems prices, (v) industry consolidation, (vi) the increasing national focus on rising fuel prices.

Unfortunately, the earlier suggest AVL systems fail to appreciate the benefits of integrated public-supplied data in the form of public complaints reported and entered into tracking systems, traffic warnings, and the use of digital mapping programs.

One type of such public-supplied data system involves the implementation of commercially-recognized safety hotline services such as those provided by SafetyFirst (www.safetyfirst.com), such as the E-Driverfile process. Typically, these types of conventional systems provide a single telephone number on a bumper sticker applied to a commercial or other vehicle. The sticker directs the a member of the public to a telephone number enabling a verbal or a digital complain regarding vehicle operation. Upon contacting the telephone number the citizen will be directed along an inquiry listing designed to generate a vehicle operation report. Such data will include a vehicle identification, possibly a license, location details, and a description of the complaint and ultimately results in an entry in a tracking database according to a specific database format desire. Unfortunately, such vehicle operation reports are necessarily subjective in nature because they are based on a human-input reporting system. No systems to date have attempted to integrate such data reports with objective AVL systems and all have failed to consider the enclosed inventive system.

Also recognized are satellite linked Automatic Vehicle Locator (AVL) Solutions such as ONSTAR® (www.onstar.com). These types of systems are based upon a vehicle located transceiver responding to an automated user-input (a call for 911 emergency assistance for example). Unfortunately, these types of consumer-based AVL systems are non-scalable, are single-vehicle based, and require an extensive human-oriented maintenance network to manage limiting their commercial viability.

Additionally known in the art are internet package tracking systems operating in near-real time such as noted in US Pub. 2005/0251330 to Waterhouse et al., the entire contents of which are herein incorporated by reference. As noted in this reference, such package tracking systems involve a vehicle, a positional location system (e.g. GPS) carried by the vehicle, the positional location system that determines geographic positional coordinates for sequential locations of the vehicle along the route thereof toward a destination, and a wireless transmitter (such as a cell phone link) that transferring the geographic positional coordinates to a central computer. In this reference, the computer system operates to provide periodic updated calculations to estimate corresponding estimated arrival time (ETA) data for a specific package to a destination and to relay this data to a customer. Unfortunately, such systems cannot be readily adapted to interlink GPS coordinates, complex reports, and other details recognized by the inventors as desired for a beneficial system.

Broadly what is not appreciated by the related art is the applicant's recognition of a technological system enabling managers of vehicle fleets to correlate subjective vehicle operation reports with actual vehicle data and public data all provided in a real time context all with a very low operational and maintenance burden.

Accordingly, there is a need for an improved system, method, and apparatus for transportation management that enables budgeting for information technology transportation expenditures, enhanced public safety, improved return on business investment and other benefits.

### OBJECTS AND SUMMARY OF THE INVENTION

One intention of the present invention is to provide a solution to at least one of the concerns noted above.

As a consequence of the proposed system additional features may optionally provide, but are not required to involve, the following benefits, based upon user and manufacturer determinations, all without departing from the scope and spirit of the present invention, namely: Enhanced Reporting, involving (1) Status Reports of a fleet's overall condition; (2) customizable customer-selectable grading systems adjustable in scale, which will be applied from a single vehicle to an entire fleet; and (3) Evaluation of a fleet's productivity levels by giving an actual dollar amount (based on various productivity measurements calculated based on tracking data) in applicable currency and the availability of viewing fleet data globally on a small cellular PDA screen.

Another object of the present invention is to provide optional, but not required elements that may be selected by a particular customer, including: (1) A fleet management system with a commercial and municipal hardware and software structure; (2) Intuitive applications, onboard Microsoft Windows™ CE.NET operating system or other operational systems including customized operating systems for a VSU (vehicle system unit) and easy to read intelligent reports to assist clients in maximizing their efficiency and profitability; (3) An available and selectable interface with PDAs, LCD and touch screens;(4) A plug-and-play interface/modem configuration for multiple network ability that accepts easy updates, start-ups, and software upgrades; (5) An optional and individually actionable “Store-Forward” (voluntary or directed) data transfer from a VSU to a management Server with no data loss; (6) electronics that minimize signal drifting and delivering greater location accuracy; (7) lengthy on-vehicle storage, (8) customizable data transfer protocols unique to each customer, (9) an optional auto-alert to ensure Homeland Security and Hazmat Compliancy or other Agency compliance; (10) Text-to-voice alerts to cell phones; (11) an improved reliability and accuracy in tracking and locating vehicles; (12) an interface to integrate external video monitoring and display equipment to the system such as LCD screen and camera system for live video/audio communication; (13) the use of TRI Band GSM/GPRS engine or other data trails; (14) voice, SMS, Data, TCP/IP, Email and other input pipeline; (15) an adjustable GPS receiver and an Integrated TXCO (receiver with an (temperature. compensated crystal oscillator), and Online Tracking capability from remote locations; (16) tracking and interfaceable with on-vehicle engine and environmental monitoring systems, and (17) linkable with configurable geo-fencing and data logging systems.

Another proposed benefit of the present invention is to provide a vehicle fleet management system enabling a variety of multiple commercial embodiments, each generating income based on a management and data or unit management schema. These types of management systems, include but are not limited to:

1. Airport Vehicle Management

2. Vehicle Roadside Assistance

3. Vehicle Maintenance Records

4. Fuel Savings reports based on driving performance.

5. Child protection reports for child transportation units.

6. Hazardous Materials Tracking systems for performance during Haz-Mat transportation.

7. 911/Emergency or Homeland Security tracking

8. Full-Contact Marketing

9. Tracking of specific Traffic and Weather conditions.

Additionally the proposed system enables the additional goals of:

1. Accurately monitoring vehicle speed, location, time, duration at time, and idling time.

2. Continuously evaluating driver ability and habits offering primary prevention against road accidents and the litigation costs associated thereto.

3. Provides mapping systems (for example, with Google Maps) with enhanced street level global mapping to pinpoint vehicle locations relative thereto.

4. Offers emergency panic button operation for homeland security and hazmat compliance restrictions and regulations.

5. Enables end to end data security transfer.

The present invention relates to a system, method, and apparatus infrastructure provide real time wireless tracking of multiple initial data parameters transmitted from individual mobile receiving or system units installed in customer vehicles. A management network receives and decodes initial data parameters from respective receiving mobile units, matches and encodes the same according to stored predetermined customer specified format preferences, and transmits customer specified data streams to customers. An additional step correlates the received specified-data streams with additional public-supplied data or third-party contractually supplied data to provide an enhanced customer report enabling a number of reports; including a credibility determination between the public-supplied data and the received specified-data, a customer vehicle travel efficiency report, a safe operation vehicle report, and a vehicle operator effectiveness report. Each vehicle system unit is functionally enabled to secure transmission of a communication protocol over GSM, GPRS, CDMA, or other networks enabling seamless and secure functionality between wireless or wired data-links.

According to an embodiment of the present invention there is provided a system for enhanced vehicle management, comprising: vehicle unit means for originating initial data, management server means, including means for receiving the initial data and means for conforming the initial data to a set of specified data, contractor server means for receiving the specified data and for receiving public-supplied data, and the contractor server means including means for assembling the specified data and the public-supplied data in a data assembly and for transmitting the data assembly to an end user interface, whereby the data assembly enables at least one of the contractor server means and the end user interface to conduct a comparison between the specified data and the public-supplied data to enhance management of a vehicle.

According to another adaptive and alternative embodiment of the present invention there is provided a system for enhanced vehicle management, further comprising: means in the vehicle unit means for receiving a GPS signal, and the vehicle unit means for originating including means for originating the initial data in real time.

According to another adaptive and alternative embodiment of the present invention there is provided a system for enhanced vehicle management, further comprising: means in the vehicle unit means for receiving a vehicle original data supply relating to a status of the vehicle.

According to another adaptive and alternative embodiment of the present invention there is provided a system for enhanced vehicle management, wherein:

at least one of the initial data and the specified data including geo-locational data relative to a corresponding geographic location of the vehicle unit means.

Additionally, another adaptive and alternative embodiment of the present invention allows interaction the present operational and management structures and code division multiple access (CDMA) networks and GSM or global location systems for mobiles (GSM) systems as proposed in WO 2000/030393, the entire contents of which are herein incorporated by reference as a general description of the same.

According to an embodiment of the present invention there is provided a system for enhanced vehicle management, wherein: the initial data includes at least one of a vehicle unit location, a vehicle unit speed, and a vehicle unit time.

According to an another adaptive and alternative embodiment of the present invention there is provided a vehicle management system associated with a plurality of customer mobile vehicle units each generating and wirelessly transmitting vehicle data parameters to a coordinating management system and each wirelessly receiving coordinating data instructions from the coordinating management system, comprising: a receiving system entity for receiving and decoding the transmitted vehicle data parameters from respective customer mobile vehicle units, a matching and encoding system entity for selecting and matching selected portions of the decoded vehicle data parameters to a predetermined customer-specified format preferences and for encoding the matched selected portions for transmission to respective a customer-specified location, and a transmission system for transmitting the matched selected portions to the customer-specified location along a customer-specified data stream.

According to another adaptive and alternative embodiment of the present invention, there is provided a vehicle management system, wherein: the receiving system entity receives additional public-supplied data relating to at least one customer mobile vehicle, a credibility determination entity for comparing the additional public-supplied data relating to the at least one customer mobile vehicle to the decoded the transmitted vehicle data parameters from respective customer mobile vehicle units to generate credibility rating and report the credibility rating to the customer-specified location along a customer-specified data stream.

According to another adaptive and alternative embodiment of the present invention, there is provided a system associated with a plurality of customers maintaining a plurality of customer mobile vehicle units in respective customer mobile vehicles, comprising: a shared infrastructure entity having a first contractual relationship with at least one shared wireless data communication infrastructure, the first contractual relationship having terms whereby the shared infrastructure entity receives a plurality of initial data parameters from respective customer mobile vehicle units transmitted by the shared wireless data communications infrastructure, the shared infrastructure entity having respective customer contractual relationships with respective ones of the plurality of customers, the customer contractual relationships having terms whereby the plurality of customers provide respective predetermined customer specified reporting preferences for the initial data parameters to the shared infrastructure entity, the shared infrastructure entity having an initial data parameter electronic storage system to receive the initial data parameters and to identify the initial data parameters to the respective ones of the customer mobile vehicle units and to encode respective identified initial data parameters according to the respective predetermined customer specified reporting preferences, the shared infrastructure entity having a third contractual relationship with at least one data communication infrastructure, the third contractual relationship having terms whereby the shared infrastructure entity transmits the initial data parameters encoded according to the respective predetermined customer specified reporting preferences to the customer.

According to another adaptive and alternative embodiment of the proposed invention there is provided a system associated with a plurality of customers, wherein: the shared infrastructure entity has a forth contractual relationship with a public-supplied data infrastructure, the fourth contractual relationship having terms whereby the public-supplied data infrastructure provides public supplied data to the initial data parameter electronic storage system, the shared infrastructure entity assembles and encodes the public supplied data with respective the encoded initial data parameters according to the respective predetermined customer specified reporting preferences, and the third contractual relationship having terms whereby the assembled and encoded public supplied data and the encoded initial data parameters are transmitted by at least one data communication infrastructure to the customer.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 provides a graphical view of one infrastructure embodiment of the proposed system noting broad relationships.

FIG. 2 provides a pictographically rendered view of an adaptive embodiment of the proposed system outlining visual image relationships.

FIG. 3 is a graphical view of an additionally detailed system infrastructure embodiment.

FIG. 4A is a first graphical representation of a database schema according to the present invention, split into two parts.

FIG. 4B is a continued graphical representation of a database schema according to the present invention, and is the second of the two parts noted in FIG. 4A.

FIG. 5 is a graphical view of an infrastructure system embodiment.

FIG. 6 is an operational flow chart view of the operations of a mobile vehicle device according to one aspect of the present invention employing the structure noted in the system of FIG. 3.

FIG. 7 is an operational flow chart view of the operations of the device adaptor application noted in FIG. 3.

FIG. 8 is an operational flow chart view of an event notify application transmitting notification of a designated event to a designated user.

FIG. 9 is an operational flow chart of the proposed web application interacting with the respective databases noted in FIG. 3.

FIG. 10 is a pictographic representation (via the Internet interface feature) of a vehicle history mapping playback according to the proposed user system and method.

FIG. 11 is a pictographic representation (via the Internet interface feature) of a vehicle history by waypoint locations according to the present invention.

FIGS. 12A and 12B are respectively pictographic representations of web-pages or electronic reports for Event Notification Management screens in the database and an event notification email.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

It will be recognized by those of skill in the art having read and understood the entire disclosure herein, that the invention, systems, and operational structures or features may be represented in a number of ways without departing from the scope and spirit of the present invention. In view of this position it will be recognized that the figures are supportive of general concepts, specific features, and specific steps of operation. Consequently, those of skill in the art of related systems, having studied the enclosed will be able to integrate the related discussions herein.

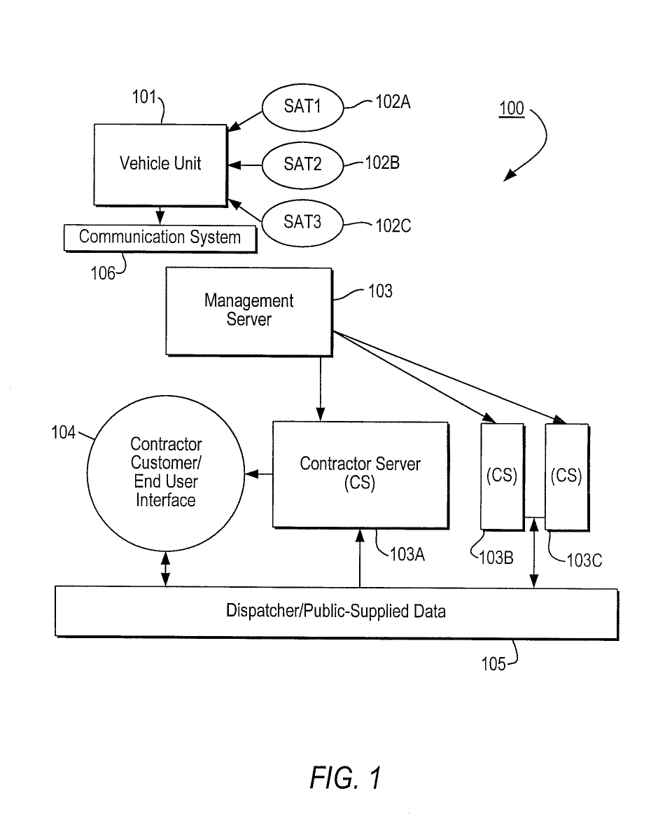

Referring now to FIG. 1, one embodiment of the proposed integrated or structural system 100 includes an initial vehicle unit 101 or mobile vehicle unit capable of determining and providing real-time unit location relative to receipt of GPS and other detailed digital signals received from positioning satellites 102A, 102B, 102C to enable a determination, via software systems within unit 101, a quantity of initial data, such as vehicle speed, location, direction, rate of change of direction, duration at a location, acceleration rate, deceleration rate, use of vehicle signals (blinkers etc.), deployment of vehicle safety equipment, vehicle operational system parameters (engine performance, etc.).

It shall be recognized by those of skill in the art that unit 101, is not restricted to the exemplary vehicle (for example a truck or car) may be instead located in any conventional movable apparatus, for example a boat, plane, container, motorcycle, and other movable apparatus without departing from the scope and spirit of the present invention. The proposed preferred embodiment below depicts use in emergency vehicles, trucking fleets, and other vehicles but is not to be so limited.

The initial data generated by vehicle unit 101 may include, but is not limited to, a location (latitude, longitude (both available in detail to minute, second), speed, and time of reading). Additional types of initial data are similarly envisioned and when incorporated with the data available in vehicle's electronic management system may include without limitation; a specific vehicle identification, an emergency status, idling time, vehicle stops, daily distance, fuel consumption, maintenance status, state fuel tax consumption, as well as unit-definable and calculate-able functions relative to a customer-determined performance standard, including sharp turns, hard breaking, hard acceleration, erratic lane change, cornering to quickly, and otherwise analyzing a driver's abilities and habits.

Thus, while the present discussion above shall be viewed as non-exhaustive, it will be recognized that the initial data available via the software in unit 101 includes a combination of the specific location data from satellites 102A-C, as well as any suitable data may be calculated by a combination of vehicle-originated data (driver identification, accelerometer data within a unit, specific signal data (for example emergency signal data), and a plurality of available function-based calculatable data based on the same).

Unit 101 at periodic and controllable and programmable intervals sends via a GPRS or other related communication system 106 to a tracking management server 103 for initial receipt and compilation. It is envisioned that such intervals may be programmed for time intervals (from for example 1 second to 30 minutes), and may also be programmed to change intervals based upon vehicle originated data (for example an emergency signal), for example to change from a 30 minute interval to a 1 second interval for a defined time period (for instance 1 hour).

As a consequence, it shall be recognized that each of the potential initial data types discussed herein may be transmitted to a selected management server 103 upon a controllable time frame and in a programmable manner.

Following initial receipt of the initial data, management server 103 accesses an internal program, database schema, and a control system (all not shown) enabling a correlation of the initial data from the vehicle to specified data according to a programmed and programmable data-base schema table within management server 103. Additionally, server 103 may access one of a plurality of contractor defined report structures based on contractor-determined needs fed from a determined contractor server 103A, 103B, 103C, etc. and incorporate this information into the development and completion of the data in management server 103.

As used herein the contractor defined report structures enable management server 103 to configure the initial data that it transmits into a desired contractor specified structure or customer server. As will be noted additionally, proposed system 100 enables integration with a plurality of contractor servers (and optionally contractor communications linkages) each with differing defined specified data without departing from the scope and spirit of the present invention.

For example, a first contractor server (CS) 103A may require a report containing only vehicle location, speed, time, and vehicle identification information, while a second contractor server 103B may require additionally thereto a distance tracking calculation, idling time calculations, and a fuel consumption report, and a third contractor server 103C may require yet more specified data including erratic lane change reports and hard breaking reports.

It shall be recognized that management server 103 may readily prepare and supply all forms of contractor specified data and even completed reports to contractor servers 103A-C via processing at the management server 103 level, or may be employed only to transmit required data streams in a customer/contractor desired format for later integration by the customer/contractor at their end. Such processing may include the use of a plurality of algorithms integrated with a mapping and tracking function, and possibly yet further integration with definable standards for specific vehicle size, weight, etc., vehicle type, vehicle-state-location-tax status, and other factors herein.

System 100 additionally recognizes that contractor servers 103A-C may receive additional sources of vehicle information. Input system 105 reflects the origination of a plurality of public-supplied data via, for example, in-situ vehicle dispatcher reports, public-performance reports, and emergency vehicle reports, public complaint reports, among others. As a consequence, Contractor servers 103A-C may receive such additional public-supplied data and integrate the same into their completed and customized reports so as to correlate the actual contractor-desired and specified-data supplied from management server 103 (alternatively a plurality of management servers), with any supplied third party supplied public data to enhance business performance.

For example, where input systems 105 provide a public-supplied visual report (via a telephonic safe-driver system input) to contractor server 103A noting an unsafe vehicle condition, and a specified-data originated stream of actual vehicle operation is provided from management server 103, contractor server 103A may provide an accuracy or performance report a contractor, customer, or end user interface 104, allowing further vehicle optimization.

In an exemplary detail, the example may be that the public-supplied visual report is of an unsafe lane change at a location and a time for a specific vehicle. In parallel, management server 103 receives vehicle unit information, or may be optionally queried by contractor servers 103(A-C) relative to speed, location, vehicle dimension, and other factors and can plot the same on a computerized map, noting for example recent road construction details supplied by State Departments of Transportation. Thus, management server 103 may then determine that the vehicle was traveling at 25 miles per hour, changed lanes onto a construction temporary road-bed outside a predetermined rate-of-change/time, but additionally received a dash-board-input report of close-following cars in heavy traffic. Thereafter, management server 103 may send a sufficient specified data to contractor server 103A to enable end user interface 104 to note un-safe driver activity or to similarly note safe driver activity under difficult traffic conditions.

As will be noted from FIG. 1, it is additionally possible that public-supplied data in 105 may be provided by a coordinative element of end user interface 104. For example, an end user interface may be a trucking fleet, wherein the coordinative element is a customer complaint phone center that feeds such complaint-data to contractor server 103A. Depending upon a particular contractor involved, specific servers and communication pathways are provided.

As a summary of the above, it is proposed that those of skill in the art, having reviewed the entire compilation noted herein will recognized that system 100 provides an enhanced system, method, and apparatus for improved transportation management.

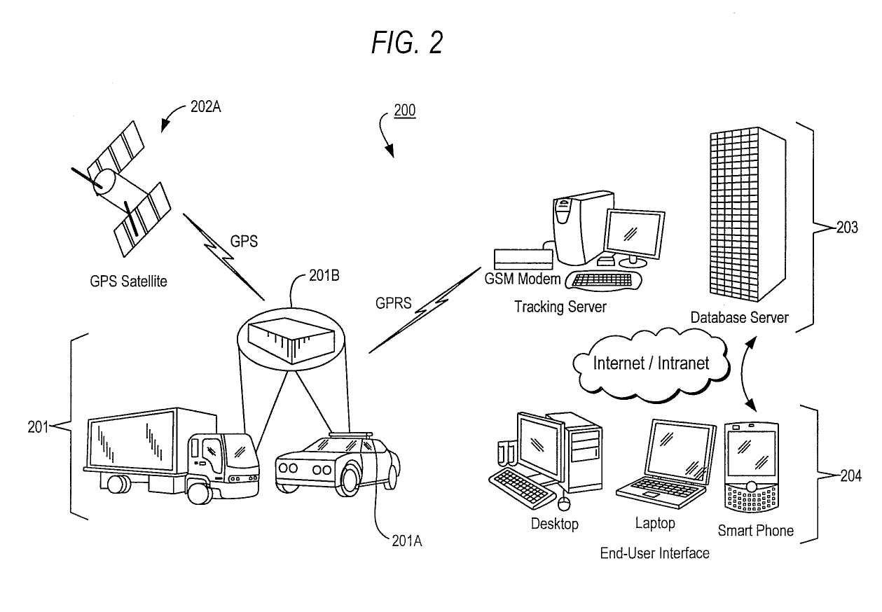

Referring additionally now to FIG. 2, a pictorially noted adaptive system 200 is provided. As noted earlier one or a plurality of vehicles 201A having vehicle location units 201B (shown jointing at 201) employing a communicating unit receive data via GPS from one or more satellites 202A. Units 201B in vehicles 201A, depending upon operational controls and programming as noted herein, may render various calculations (for example acceleration) to determine vehicle speed, location, etc., and similarly may gather a plurality of vehicle-system-generated (for example a system-computer generated maintenance log and fuel level) and transmit the same gathered and calculated initial data to a management server 203.

Thereafter, management server 203 (or multiple management servers) correlates the initial data into a customer specified data format and transmits the same to an end user interface 204 via a web-enabled interface, as will be further discussed.

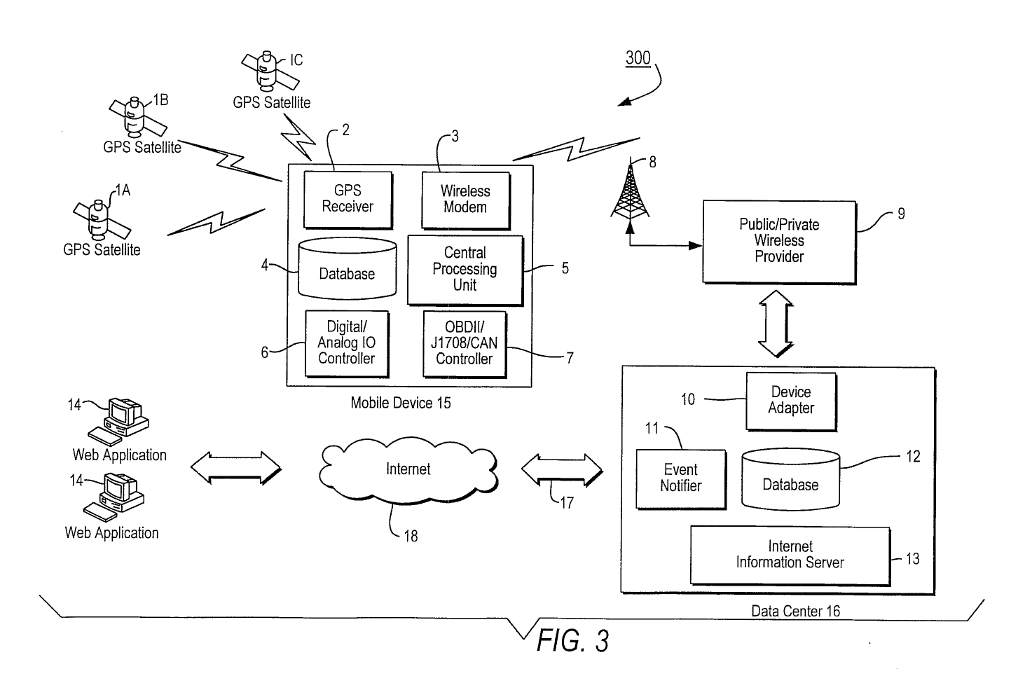

Referring now to FIG. 3, a pictographic overview of the proposed system 300 is provided according to another embodiment of the present invention. As shown, a plurality global positioning system (GPS) satellites 1A, 1B, 1C constantly send position coordinates to any available receiving unit. A mobile device 15 in a mobile vehicle unit (not shown) includes a GPS Receiver 2 that receives GPS coordinates from GPS Satellites 1A, 1B, and 1C. Also contained in mobile device 15 are a wireless modem 3 which receives and transmits data to a public or private network provider, a mobile device database 4 to store history data and system configuration, a mobile device CPU 5 which provides a core processing of mobile device 15.

Also included are a digital and analog controller 6 used for monitoring fixed and/or variable signal inputs also controls the state of signal outputs (This is used for external peripherals), and a OBDII/J1708/CAN interface controller 7 (this is used to interface with on-board vehicle's computer system which reports vehicle system status).

A network provider wireless network tower 8 (where the Mobile Devices communicate) links with a public/private wireless network provider system 9 (i.e. Verizon, ATT, or WiFi, etc.).

Thereafter a management data center 16 includes a mobile device adapter (MDA) 10 discussed later, which serves as the mobile communications application which interfaces with all mobile devices. An event notifier system 11 is also included and functions to receive events from mobile devices and to send them via Email or SMS messages to an end user as shown. A system database 12, where all history and configuration data is stored for the entire system, is provided in data center 16, as is an internet information server 13 which interfaces with all the workstations downstream at 14 via a web browser 17 and the Internet 18 to provide end user interface to manage data and mobile devices configuration.

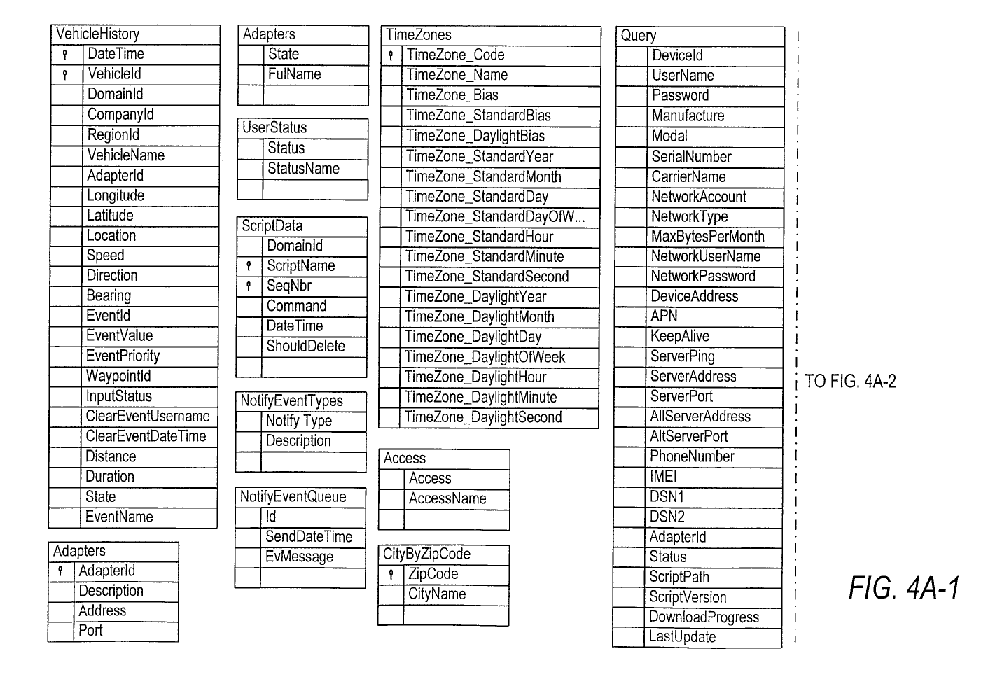

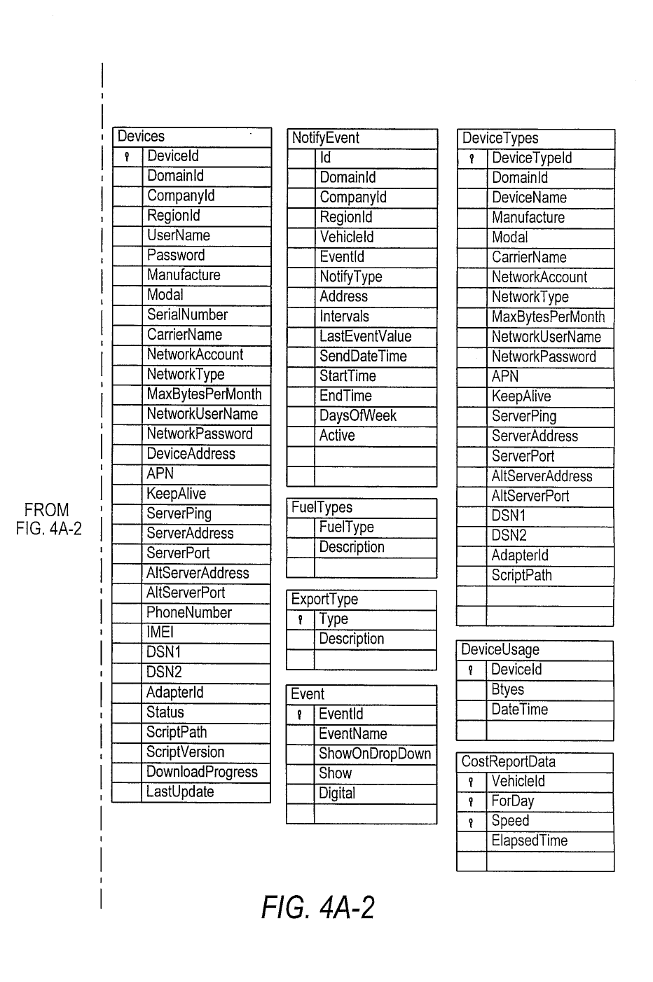

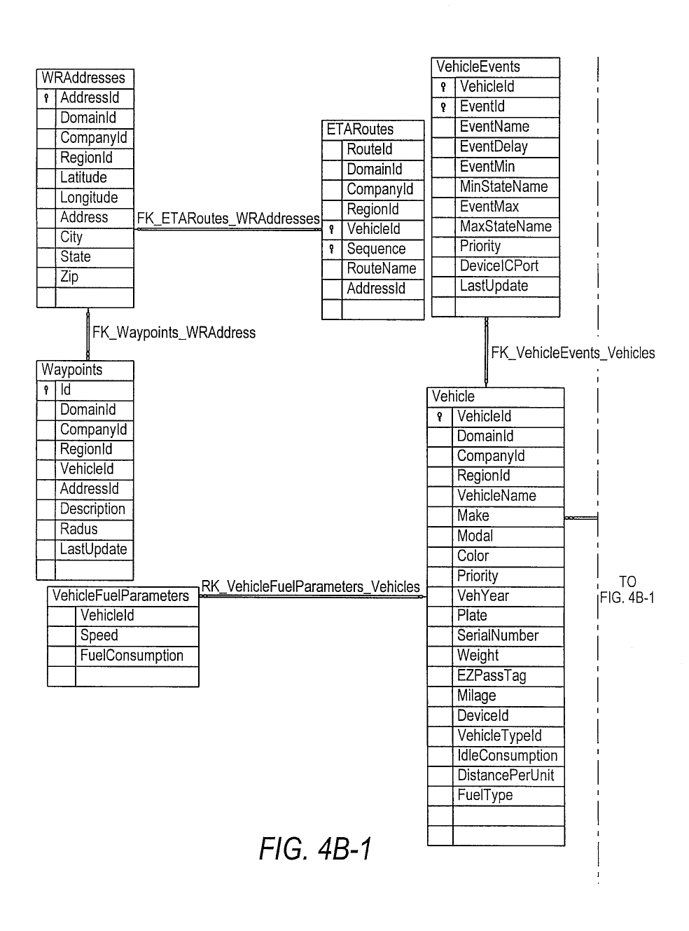

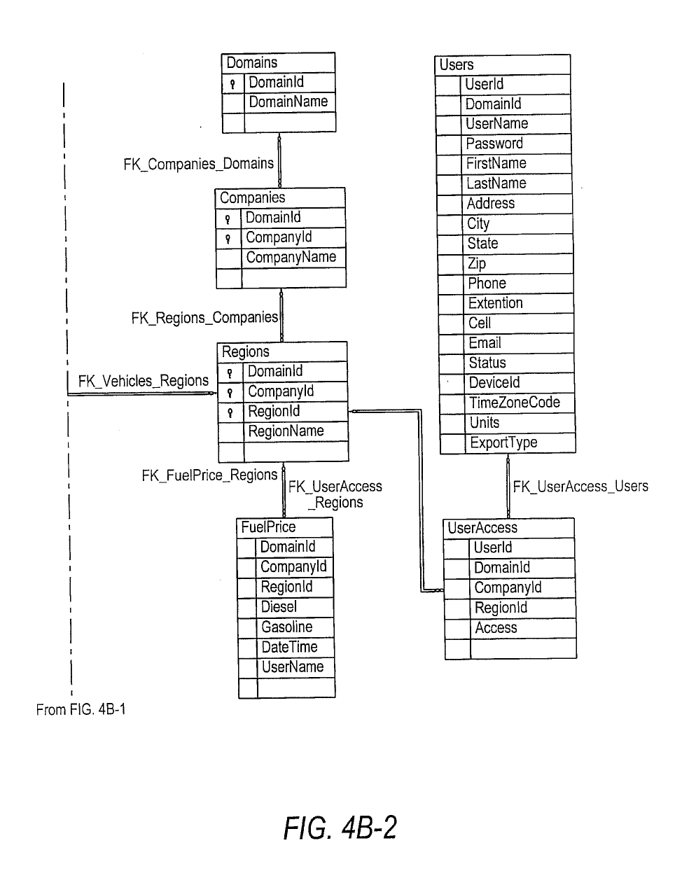

Referring now to FIGS. 4A and 4B, an exemplary database schema for the proposed system is provided. The proposed system 300, noted in FIG. 3, and particularly the proposed management system in data center 16, and database 12 therein includes an operating database schema, as illustrated. As will be seen, the schema is organized in a table structure including Domains, Companies, Regions, and Vehicles. Therefore, Domains contains Companies, Companies contains Regions, and Regions contains Vehicles, and so fourth along computer programming logic. The data is access by using a Web browser application (not shown) via a management application operating and controlling access to data center 16. This management application connects to central servers in data center 16 or elsewhere to store and retrieve data using Secure Socket Layer (SSL) methologies to encrypt the data transfer according to the database schema structure noted in FIGS. 4A and 4B, and the descriptive connections and language blocks used therein.

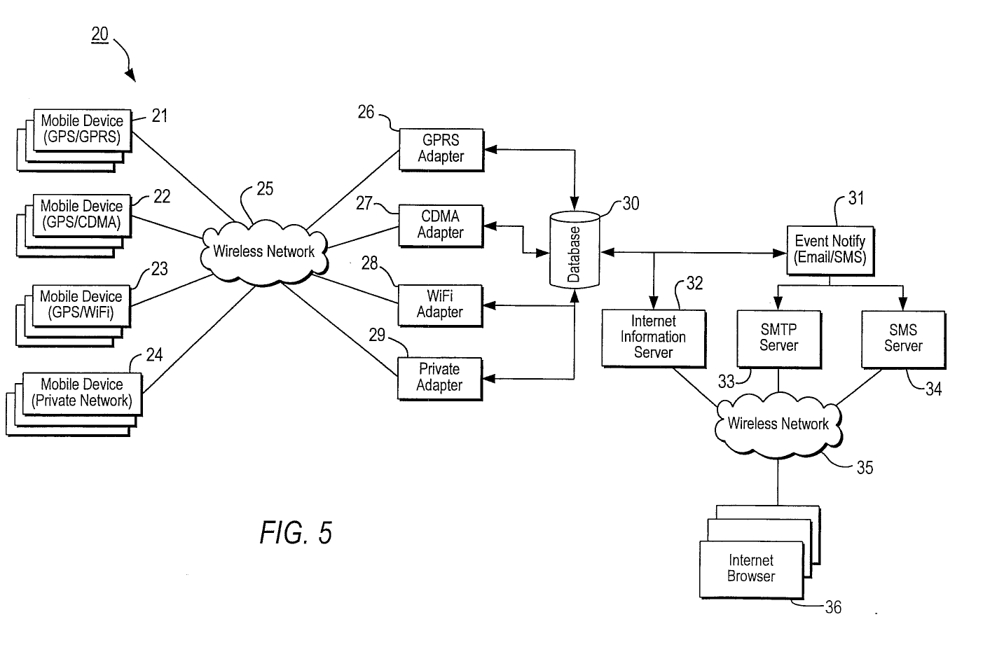

Referring now to FIG. 5, a system connectivity structure and system 20 is provided for enabling infrastructure communication between aspects of the present inventive system 300 noted in FIG. 3.

As depicted, a GPRS mobile device 21 uses (for example an ATT based network) a network for connectivity and data transport to the Data Center and a CDMA mobile device 22 uses a Verizon Network for connectivity and data transport to the Data Center 16. A Wi-Fi mobile device 23 uses local private network for connectivity and data transport to the Data Center and a private mobile device 24, uses wide are private network for connectivity and data transport to the Data Center. All join a wireless network 25.

A GPRS adapter application 26 resides in the data center and is responsible for connectivity to the network provider and the mobile devices on the GPRS network. A CDMA adaptor application 27 also resides in the data center and is responsible for connectivity to the network provider and the mobile devices on the CDMA network. Similarly a Wi-Fi adapter application 28 resides in the data center and is responsible for connectivity to the network and the mobile devices on the Wi-Fi network. A private adaptor application 9 similarly resides in the data center and is responsible for connectivity to the network provider and the mobile devices on the Private network.

In the data center system database 30 a plurality of data regarding history, user and vehicle management, configuration, and logging are stored. An event notifier application 31 receives events from the various Adapters, checks the database of whom (the customer/subscriber) is subscribed to receive the event and how it is to be sent, either Email or SMS messaging. Thereafter an internet information server (IIS) application 32 is responsible for managing the end user web application, and data and transmitting the same at a suitable time in a suitable format. A SMTP (simple mail transfer protocol) server 33 application is responsible for communicating with an Email Server and send Emails. A SMS (short message service) application 34 is responsible for communicating with an SMS Server and send messages. An internet network access portal for the network 15 is provided along with an internet browser 36 for displaying the user interface application during user interaction.

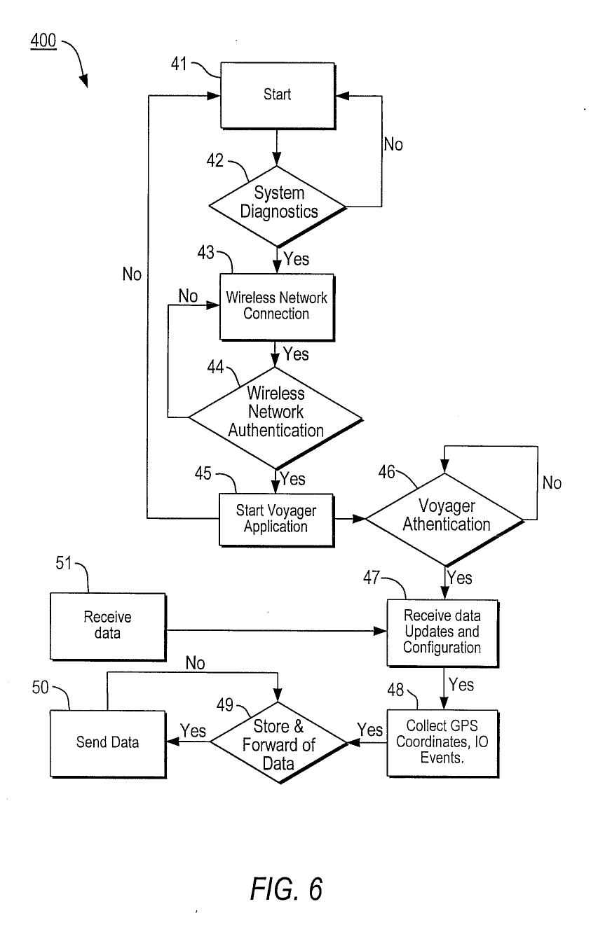

Referring now to FIG. 6 a representative flow chart is provided for a mobile device application process 400 employing the present applicant's ‘Voyager’ system, as noted. The logical flows are noted and the elemental steps are noted as follows during operation. Mobile device is powered on 41. System 400 runs diagnostics 42 to make sure all components are in working order and system 400 verifies 43 that there is network connectivity (in-range). Next system 400 tries to authenticate 44 with network provider with SIM card credentials and if authenticated system 400 begins to operate the proposed vehicle system unit application 55 (start the Voyager application). The application then sends an authentication message 46 with the necessary credentials to the Adapter application in the data center 16 (FIG. 3 or elsewhere). If authentication is successful, the Adapter application sends application updates and configuration 47 to the mobile device for further operation. If authentication failed the Voyager VSU application will repeat the process indefinitely in intervals of 1 minute.

Thereafter, collection of GPS coordinates and monitoring of signal events begins at 48. These events are stored in the local database and set for sending at a later time except for emergency events which are stored and sent immediately on a much shortened interval for brief periods of duration.

A store and forward step 49 for such data is accomplished by a configurable interval specified by the configuration. The data is stored and then forwarded to the Data Center. Thereafter the send data module 50 processes data to be sent and guarantees that data will be delivered and the receive data module 51 is responsible for receiving data.

As will be appreciated by those of skill in the art having studied the proposed invention discussed in detail herein, the mobile device (named VoyagerVSU for convenience) once is powered up, runs through a system diagnostics at which time it verify the hardware memory, peripherals, CPU (central processing unit) is fully operational. Once the diagnostics are completed the Voyager VSU application starts. As outlined in FIG. 6, the sequence of initialization are, verifies that a wireless modem exists, verifies that a Wi-Fi modem exists, checks for network existence and connectivity, selects quality of service (also knows as QOS, this is a process of selecting the most cost effective network), authenticates with the network provider using username and password (depending on network provider a modem identifier is also authenticated with). Once a network connection is established it will try to authenticate with the proposed managing servers. This process is accomplished by sending a message (or packet) over the network which contains a username, password, modem id, and the date/time of the last configuration update. The mobile application 400 waits for about 1 minute for a response from the server application (called optionally a “Device Adapter Application” (see for example feature 10 in FIG. 3 of data center 16).

If the response time expires the mobile application repeats the process indefinitely in intervals of 2 minutes. Should a negative response be returned from the Device Adapter Application the retry intervals of 2 minutes will apply. Once a positive response is received from the Device Adapter Application, a configuration message will be received with any new configuration parameters and application updates, if no parameters have been changed then a date/time is return informing the device application that there are no updates for configuration or application updates. After completion of updates the device will start collecting GPS information in the form of Latitude, Longitude, Speed, Direction, and Date/Time. This GPS information is collected, stored locally, and processed through the application algorithm which is controlled by the configuration parameters.

The application algorithm determines when the GPS information gets stored, when it gets sent, also collects GPS information based on pre-set speeds stored in the configuration parameters to determine vehicle fuel usage.

The device application also monitors the device digital and analog inputs for state changes (on or off). There is a digital input dedicated for engine on or off, another dedicated digital input for emergency/panic switch. The remaining digital inputs are for additional monitoring of doors, or any other peripheral that utilizes digital outputs. The analog inputs are used for temperature monitoring of vehicle refrigeration devices or monitor vehicle voltages. The mobile device also contains a “3 axis motion sensor” which monitors “G” forces (accelerometer, etc.). These forces are monitor by the application to determine if the vehicle is doing hard braking, fast acceleration, and sharp turns. There is also a CAN interface (Controlled Area Network) that allows the device to communicate with the vehicle on-board computer to obtain vehicle diagnostics, actual speed, accelerator position, air bag deployment, and all other vehicle supplied sensor data. Ultimately, all messages parameters are delimited by using “|” (pipe) and ending with a CRC 16 (Cyclic Redundancy Check, 16 bit) for data integrity checking to secure the transmission.

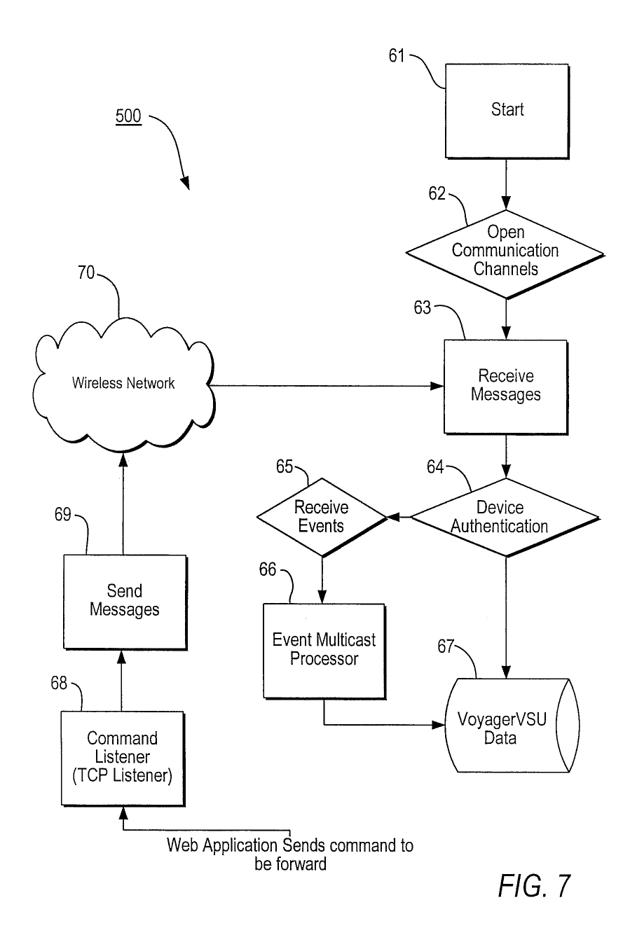

Referring now to FIG. 7, a device adapter application flow 500 is discussed in the context of system 300 shown in FIG. 3. As depicted, the first step involves a device adaptor application start 61 (this is a windows operating system service application). Next communication channels are opened 2 to the network providers and the application 500 starts to listen for incoming messages from mobile devices specific to the network it belongs too. Similarly, a receive module waits for incoming messages 63 from devices, and upon receiving an authentication message 64, credentials an authentication message by verifying against database data. If successful, the application reads mobile device configuration and sends it to the device via send message module 69.

Events are received in module 65 and stored in the database, and are additionally they are sent to the event multicast processor module 66. All events are multicast over the network to be processed by the events notify application which is described later in this document. A system database 67 is provided where all data and configuration is stored (noted as Voyager VSU) data, and this module also includes a processor for listening 68 for commands issued by the web application such as “device update” which occurs every time a user changes configuration for a device (in this way device updates and user changes are automatically processed thereby reducing service maintenance costs).

Thereafter a processing module 69 sends data processes and formats messages to be sent to the device, if the device is not authenticated, the module will store the data to be sent and resend it when the device logins in further. Additionally, a wireless provider network 70 (i.e. Verizon, ATT, Wi-Fi, and Private Networks) is involved to operationally transmit additional details.

Broadly discussed, the device adapter application or infrastructure shown at 500 is responsible for the connectivity states of all mobile devices and involves the middleware between the mobile devices and the management servers application databases.

Upon a start-up the device application connects to the database, if connectivity fails it will store any data received by the device in the local hard drive for later retrieval and database update. Also the device application 400 will start to listen on the networks for incoming connections requests from the mobile devices. When the application received a connection request, it creates an internal memory object with all of the mobile parameters that are defined in the management server's database. This electronic programming object is responsible for receiving and sending data to the mobile device. The object also has database connectivity to retrieve and store data to the database. The object is responsible for parsing the receiving messages from the mobile device, generate messages to be sent to the device, authenticates the device, verify if any configuration or application updates need to be sent, reverses-geocoding from GPS data (converts latitude and longitude to real addresses) to be stored in the vehicle history table in the Managing Server's database.

As discussed, the device adapter also listens for commands from the management application (web management application). These commands are to inform the device adapter application that configuration changes have occurred and to push a new set of configuration parameters to the mobile device for installation. If the mobile device is not connected, the device adapter will store this command in the database and send the configuration parameters the next time the device makes a successful connection. The device adapter application or system or infrastructure 500 also opens a multicast UDP (user datagram protocol) communications on the network and sends every GPS information message received from all devices, this message is then consumed by the event notify application, discussed hereafter.

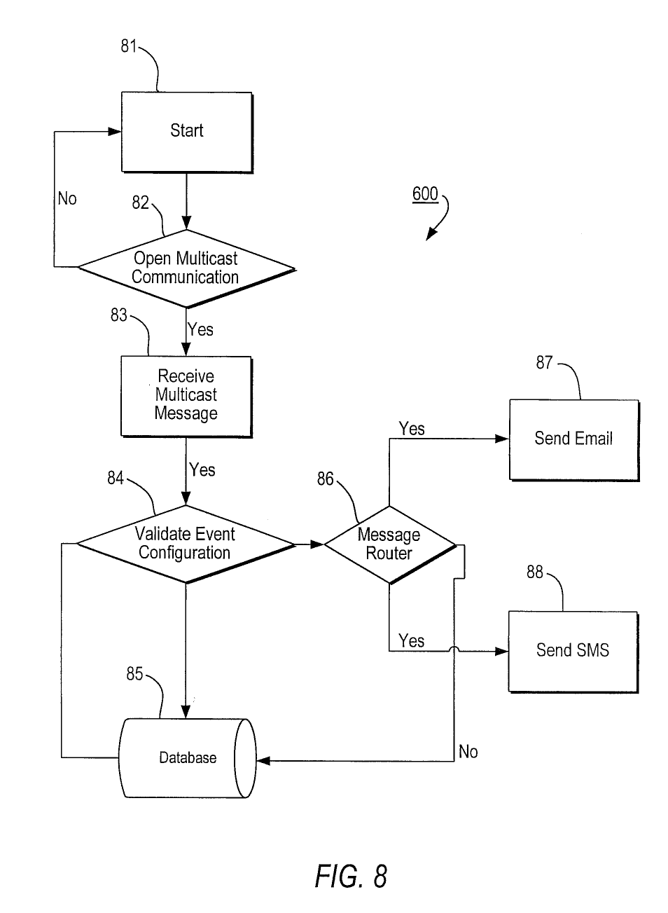

Referring now to FIG. 8, the event notifying or notification application 500 is depicted. As noted, the event notify application (see module 11 and data center 16 in FIG. 3), will start 81 (a Windows Operating System Service Application) and engage in opening multicast communications 82.

During operation event messages are received 83, parsed, and sent to the validate event configuration module 84. The validate event configuration module 4 reads the users data subscription of which events need to be processed and then they are sent to the message router module 86. A system database module 85 is interlinked where subscription data is stored, and message router module 86 determines which a method for processing an event notification. This determination is based on the customer's subscription configuration that is stored in database 85. If a message is unable to be delivered to its destination it will be stored on database 85 for later re-sends until completion is achieved. Thereafter the email module 87 sends smtp messages to a email server and a sms module 88 sends sms messages to a sms server.

As broadly discussed in relation to FIG. 8, the event notify application 600 (see module 11 in FIG. 3) is responsible for sending event notifications to a user via either Email or SMS messaging. When the event notification application starts-up, it will make a connection to the managing server application database to obtain any initialization/configuration parameters. It will start to listen on a multicast UDP communication network for GPS information message coming from the Device Adapter Application.

Additionally, the event notify application 600 retrieves subscription information from the database to verify if a specific GPS information message needs to be sent to a user. The GPS information messages can be any event which is generated by the mobile device (i.e. Speeding, Hard braking, Sharp turns, change of state in the digital inputs, exceeded threshold settings on the analog inputs, etc. . . . ). During operation, even if the application 600 event matches a subscription entered in the database it will process the event by sending the data via Email or SMS. The type of notification transport is defined by the user whether is Email, SMS, or both.

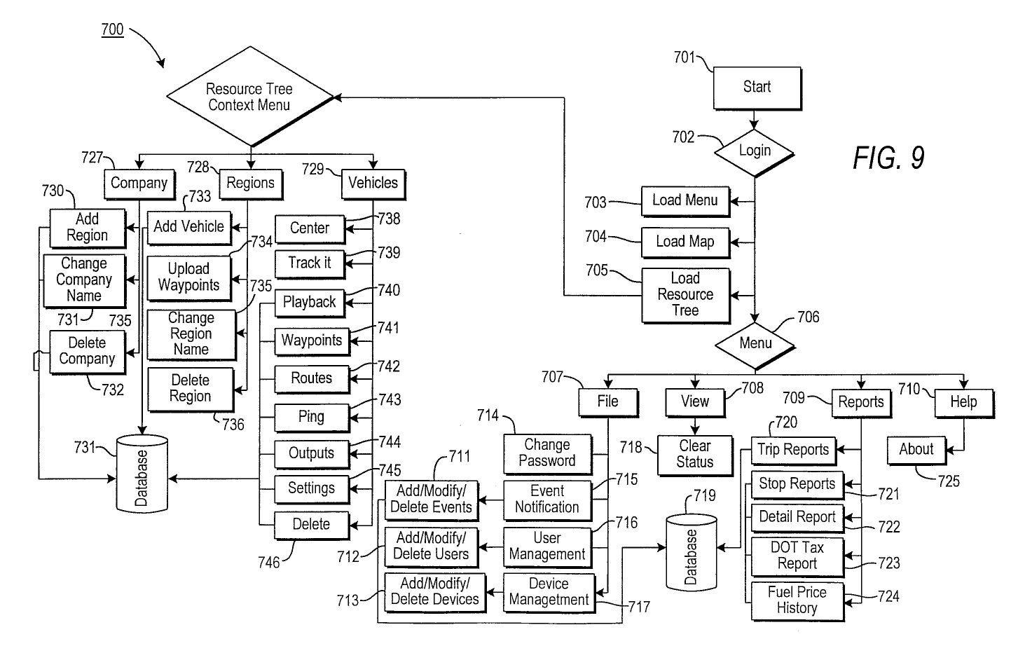

Additionally referring now to FIG. 9, wherein a managing web application system 700 is discussed. As will be recognized, the proposed Manager Application 700 is web based and interfaces seamlessly with the server databases for storing and retrieving application data, wherever located based upon customer requests and details. Starting at a user step 701-702, a user invokes the application by typing a URL address on a web browser. A connection is made to the Data Center's Internet Information Server and the management application starts with the following steps: (1). A login screen is displayed (2) where the user must enter a username, password, and domain name. After a successful login the application loads the main menu (3), a map (4), and its resources which are the vehicles (5) that the user has permissions/access too (see steps or modules 703-709). After the application is fully loaded the user has the ability (based on permissions) to navigate through the application (6) as described in FIG. 9 via the remaining steps 709-746 in full detail. When a change in vehicle unit device settings (module or step 45) or waypoints (module or step 41) is desired, the application sends a command to the Adapter (described above) to trigger a configuration update to be sent wirelessly to the device within the vehicle.

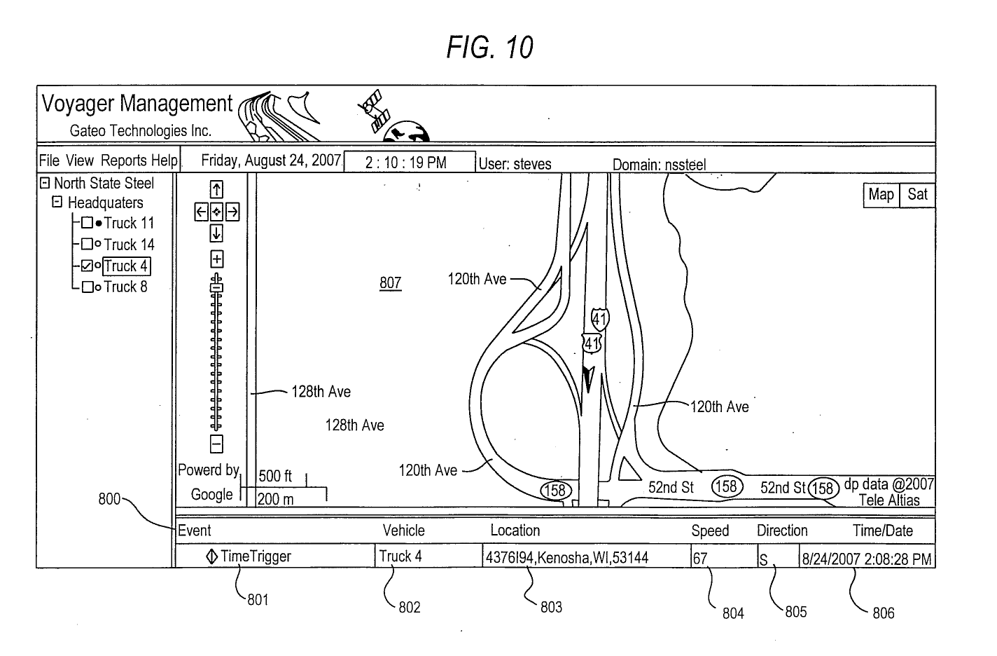

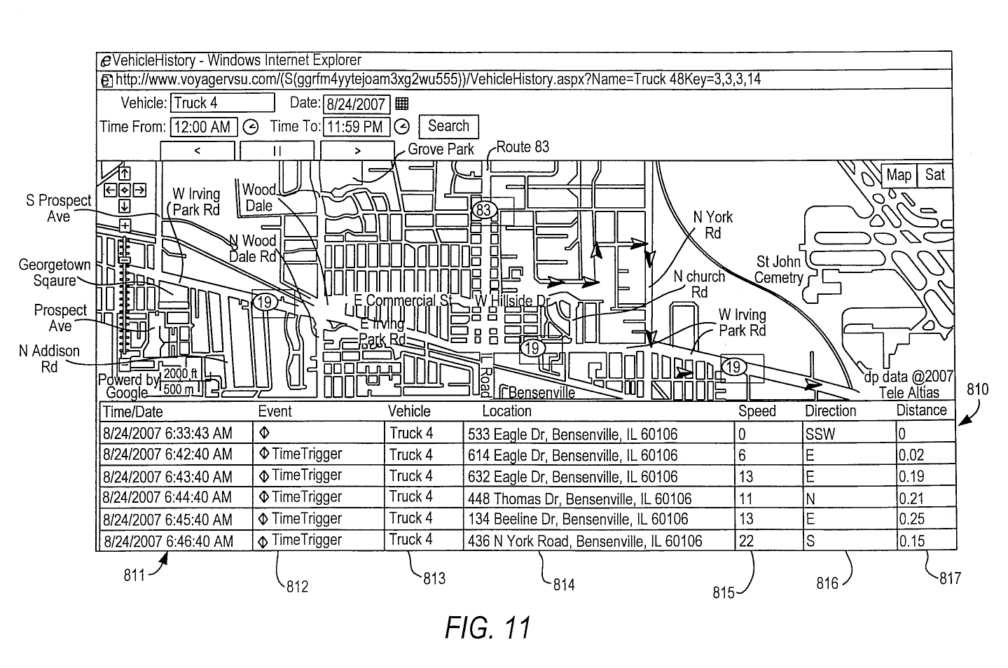

Referring additionally now to FIGS. 10 and 11 pictographic representations of a user interface display are shown. As noted in FIG. 10, at event table 800, a time trigger 801 is displayed and tracked along with a specific customer vehicle 802, a precise GPS location related to an address at 803, the indicated speed 804, direction 805, and time/date 806 all relative to a displayed map 807. This table would be an example of a vehicle history table on a play back or a monitoring mode.

FIG. 11 is a related tracking table for a vehicle history in relation to a map, wherein the tracking table 810, tracks periodic events by a time/date at 811, an event descriptor 812 (e.g., engine on or stop), then a specific vehicle 813, location 814, speed, 815, direction 816, and distance 814 between waypoints.

As exemplified by the charts in FIGS. 10 and 11 it will be readily apparent that the proposed system allows ready tracking of the vehicle on a real-time basis, cross-linked to geo location, vehicle parameters, and designatable to a specific customer vehicle according to a customer contract feature. The present system envisions that customers may desire differing degrees of tracking, report generation, data access, etc. all allowing different contract features to be built into a customized customer access portal.

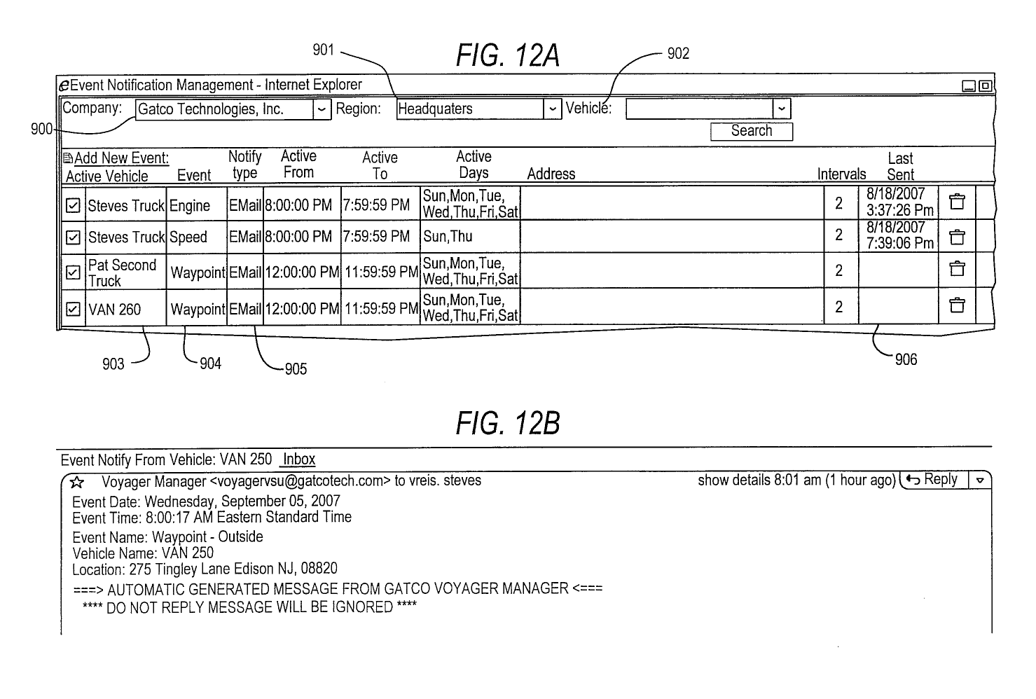

Referring now to FIGS. 12A and 12B regarding Events Tracking and management and notification aspects of the proposed system, a respective exemplary web-portal screen view is shown in FIG. 12A for a specified identified client customer 900, in a selectable region 901 for a selectable vehicle 902. In FIG. 12A, the display table indicates active vehicles 903, an event 904, the designated notification instruction (email, call, SMS, etc.) at 905, an activity range and activity detail with an address in the related columns, and a track of the transmitted event notification time in 906. As will be appreciated from the screen shot itself, each event is individually selectable to access the complete data available within the database schema.

As noted in FIG. 12B, an example of an email event notification 907 is provided, which would be received by a fleet dispatcher based upon selectable preferences.

As will be apparent from the selected screen images in the preceding images, the present invention supports an interactive interface between a management or system server alternatively called a data center and a fleet dispatcher and even the individual vehicles and drivers. The above noted selectable features operate in a windows-format where data is readily accessible for all of the fields noted in the schema as well as more prosaic details such as company contact information, vehicle call numbers and licenses, etc. In this way, the proposed system can either generate end-user (or final-form-type) reports in a format specified by a customer (for example the event log in FIG. 12A), or may generate data streams transmitted to a customer (Fleet manager) in a customer-specified format for integration into the customer (Fleet managers) fleet management system. As a result, those of skill in the art having studied the current disclosure will recognize that the present invention provides the infrastructure and the features to coordinate a divergent set of non-linked features in an operating electronic and system infrastructure.

In a similar way, the proposed system will allow web interface users to determine limits of various fixed sensors such as what will occur when a speed of 75 mph occurs. Similarly, fuel parameters may be readily tracked and managed by intervals as the system recognizes the speed, distance, and duration to calculate fuel consumption.

Ultimately, the system reports may be designated as deliverable by text, email, SMS, facsimile or merely a secure access portal.

Those of skill in the art, having learned from the present disclosure will additionally recognize that the present invention allows a plurality of contractual relationships (for example between the operator of a data center, a fleet manager having a variety of automated vehicles leasing, renting or owning vehicle management units, a GPS information service provider, a cellular communication service provider, an internet linkage service provider and others. The present system envisions a number of business entities or individuals—acting as contracting parties—that would form contracts in writing or orally/electronically that have the contract features noted above to achieve the above-described results. For example, while the mobile device may relay wireless signals using any known conventional protocol for data transfer, the parties may desire an additional level of security and contract to encode their wireless signals thereby preventing unintended capture and disassembly by competing service providers.

As discussed above the proposed system includes three or more parts, including a GPS location determination function including the satellites and signals, a wireless data network to link with out-of-office fleet vehicles, and a vehicle unit system for monitoring the location, movements, status, and behavior of a vehicle. This is achieved through the combination of the electronic vehicle location unit fitted in the vehicle and a method of returning the data complied from the unit to a customer fleet operator via a computerized communication pathway. Additionally, publicly supplied data (including traffic reports, geomapping, vehicle operation reports, and others) may be integrated either by the customer fleet operator directly or by the data center with the tracked data. This system therefore allows the creation of a pay-for-service type system based upon contractual relationships, degree and amount of data and user-access desired, frequency of formal reporting, and other factors as discussed herein. Consequently, the present invention may be viewed as a contract-oriented infrastructure.

It will also be recognized by those of skill in the art having read and understood the entire disclosure herein that the phrases vehicle receiving units (VSU), mobile vehicle units, vehicle unit means, vehicle receiving and transmitting units (VRTU's), mobile device, Voyager Units, Voyager, or related phrases shall mean the computerized systems enabling receiving of information (such as GPS coordinates or signal quality indicators) and transmission of initial data parameters from respective transportation or other vehicles to a receiving system.

Those of skill in the art of managing computerized data systems will additionally recognize that this disclosure may employ the phrase ‘voyager’ also in terms of managing or operational software for the mobile vehicle units or the coordinating databases and other infrastructure software that enables the proposed automatic or automated vehicle location and tracking system. The use of the phrase ‘voyager’ will not so limit the particular context of use, but it will be recognized as a generally descriptive phrase. For example, the phrase ‘voyager system’ may be employed to generally represent, in part, an enhanced automatic vehicle location (AVL) system, but is not limited by the descriptor location and may be broadly employed as indicative according to the context of use, for example as a mobile resource management (MRM) system when discussing the broader application of the present invention. Similarly, from the context applied the phrase voyager system unit (VSU) will be recognized as related to but different from a convention vehicle system unit (Conventional VSU) due to the additional enhancements the present system allowing manipulation and compilation of returning data compiled from a vehicle unit and other systems.

A system, method, and apparatus infrastructure provide real time wireless tracking of multiple initial data parameters transmitted from individual mobile receiving or system units installed in customer vehicles. A management network receives and decodes initial data parameters from respective receiving mobile units, matches and encodes the same according to stored predetermined customer specified format preferences, and transmits customer specified data streams to customers. An additional step correlates the received specified-data streams with additional public-supplied data or third-party contractually supplied data to provide an enhanced customer report enabling a number of reports; including a credibility determination between the public-supplied data and the received specified-data, a customer vehicle travel efficiency report, a safe operation vehicle report, and a vehicle operator effectiveness report. Each vehicle system unit is functionally enabled to secure transmission of a communication protocol over GSM, GPRS, CDMA, or other networks enabling seamless and secure functionality between wireless or wired data-links.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A system for enhanced vehicle management, comprising:
vehicle unit means for originating initial data;
management server means, including means for receiving said initial data and means for conforming said initial data to a set of specified data;
contractor server means for receiving said specified data and for receiving public-supplied data; and
said contractor server means including means for assembling said specified data and said public-supplied data in a data assembly and for transmitting said data assembly to an end user interface, whereby said data assembly enables at least one of said contractor server means and said end user interface to conduct a comparison between said specified data and said public-supplied data to enhance management of a vehicle.

2. A system, for enhanced vehicle management, according to claim 1, further comprising:
means in said vehicle unit means for receiving a GPS signal; and
said vehicle unit means for originating including means for originating said initial data in real time.

3. A system, for enhanced vehicle management, according to claim 2, further comprising:
means in said vehicle unit means for receiving a vehicle original data supply relating to a status of said vehicle.

4. A system, for enhanced vehicle management, according to claim 1, wherein:
at least one of said initial data and said specified data including geo-locational data relative to a corresponding geographic location of said vehicle unit means.

5. A system, for enhanced vehicle management, according to claim 1, wherein:
said initial data includes at least one of a vehicle unit location, a vehicle unit speed, and a vehicle unit time.

6. A vehicle management system associated with a plurality of customer mobile vehicle units each generating and wirelessly transmitting vehicle data parameters including location data to a coordinating management system and each mobile vehicle unit wirelessly receiving coordinating data instructions from said coordinating management system, comprising:
a receiving system entity for receiving and decoding said transmitted vehicle data parameters from said respective customer mobile vehicle units;
a matching and encoding system entity for selecting and matching portions of said received and decoded vehicle data parameters to a predetermined customer-specified format preferences and for encoding said matched selected portions for transmission to respective a customer-specified location; and
a transmission system for transmitting said matched selected portions to said customer-specified location along a customer-specified data stream.

7. A vehicle management system, according to claim 6, wherein:
said receiving system entity receives additional public-supplied data relating to at least one customer mobile vehicle.

8. A vehicle management system, according to claim 7, further comprising:
a credibility determination entity for comparing said additional public-supplied data relating to said at least one customer mobile vehicle and to said decoded said transmitted vehicle data parameters from respective customer mobile vehicle units, whereby said vehicle management system enables a generation of a vehicle operator performance rating and a reporting data set for transmission along a customer-specified data stream.

9. A vehicle management system, comprising:
a plurality of customer mobile vehicle units in respective mobile vehicles;
said customer mobile vehicle units electronically associated with respective ones of said mobile vehicles and each wirelessly receiving location data from a wireless location data transmitting source and encoding and wirelessly transmitting vehicle data parameters including said location data to a coordinating management system for said vehicle management system;
a receiving system entity for receiving and decoding said transmitted vehicle data parameters from respective customer mobile vehicle units;
a matching and encoding system entity for selecting and matching portions of said received and decoded vehicle data parameters to a predetermined customer-specified data format preference;
said matching and encoding system entity including a schema data management entity for storing and for encoding said matched selected portions for transmission to respective a customer-specified locations in customer-specified formats; and
a transmission system for transmitting said matched selected portions to said customer-specified location along a customer-specified data stream.

10. A vehicle management system, according to claim 9, wherein:
said receiving system entity receives additional public-supplied data relating to at least one customer mobile vehicle from a source external to said respective customer mobile vehicles.

11. A vehicle management system, according to claim 10, further comprising:
a credibility determination entity for comparing said additional public-supplied data relating to said at least one customer mobile vehicle to said decoded said transmitted vehicle data parameters from respective customer mobile vehicle units to generate a credibility rating and report said credibility rating to said customer-specified location along a customer-specified data stream.

12. A system associated with a plurality of customers maintaining a plurality of customer mobile vehicles, comprising:
a plurality of mobile vehicle units in respective ones of said plurality of customer mobile vehicles vehicle units;
a shared infrastructure entity having a first contractual relationship with at least one shared wireless data communication infrastructure, said first contractual relationship having terms whereby the shared infrastructure entity receives a plurality of initial data parameters from respective customer mobile vehicle units transmitted by said shared wireless data communications infrastructure;
said shared infrastructure entity having respective customer contractual relationships with respective ones of said plurality of customers, said customer contractual relationships having terms whereby said plurality of customers provide respective predetermined customer specified reporting preferences for said initial data parameters to said shared infrastructure entity;
said shared infrastructure entity having an initial data parameter electronic storage system to receive said initial data parameters and to identify said initial data parameters to said respective ones of said customer mobile vehicle units and to encode respective identified initial data parameters according to said respective predetermined customer specified reporting preferences;
said shared infrastructure entity having a third contractual relationship with at least one data communication infrastructure, said third contractual relationship having terms whereby the shared infrastructure entity transmits said initial data parameters encoded according to said respective predetermined customer specified reporting preferences to said customer.

13. A system associated with a plurality of customers according to claim 12, wherein:
said shared infrastructure entity has a forth contractual relationship with a public-supplied data infrastructure, said fourth contractual relationship having terms whereby said public-supplied data infrastructure provides public supplied data to said initial data parameter electronic storage system;
said shared infrastructure entity assembles and encodes said public supplied data with respective said encoded initial data parameters according to said respective predetermined customer specified reporting preferences; and
said third contractual relationship having terms whereby said assembled and encoded public supplied data and said encoded initial data parameters are transmitted by at least one data communication infrastructure to said customer.

14. A method for improved transportation management, comprising the steps of:
providing a plurality of mobile vehicle units in respective ones of a plurality of mobile vehicles;
receiving and storing wireless location data in respective ones of said plurality of mobile vehicle units;
providing a plurality of vehicle data parameters as initial vehicle data from said respective vehicles to respective ones of said mobile vehicle units and encoding the same;
transmitting said, encoded initial vehicle data and said location data from said ones of said mobile vehicle units to a receiving system entity for receiving said transmitted initial vehicle data and said location data;
providing a matching and encoding system entity for selecting and matching portions of said encoded initial vehicle data and said location data to a predetermined customer format specified by a customer operating ones of said plurality of mobile vehicles; and
transmitting said selected and matched portions of said encoded initial vehicle data and said location data to a customer-specified location along a customer-specified data stream.
